(19) United States
(12) Patent Application Publication
(10) Pub. No.: US 2001/0017485 A1
(43) Pub. Date: Aug. 30, 2001

(54) Control system and method for switching and intercepting power supplies

(76) Inventor: Wan Sik Yoo, Seoul (KR)

Correspondence Address: Lawrence A. Steward, Esq., Brinks Hofer Gilson & Lione, Suite 2425, One Indiana Square, Indianapolis, IN, 46204, US

(21) Appl. No.: 09/730,070

(22) Filed: Dec. 5, 2000

Related U.S. Application Data
(63) Continuation-in-part of application No. 09/313,754, filed on May 27, 1999, now abandoned.

(51) Int. Cl. H02J 9/00

(52) U.S. Cl. 307/66

(57) ABSTRACT

A control system for switching and intercepting power supplies which can reduce the generation of arc during the switching operation of main and backup power supplies and adjust the delay time required for the switchover of the power supplies. The control system includes a phase signal input section for detecting phases of the main and backup power supplies, a reference voltage generating section for generating a reference voltage, a supply voltage signal input section for detecting voltages of the main and backup power supplies, and a control section for receiving and processing output signals of the phase detecting section, reference voltage generating section, and supply voltage detecting section. The control section outputs a power switching control signal to the power switching section, a trip signal to the power intercepting section when a voltage of the main or backup power supply deviates from a normal supply voltage range, and a return signal to the power intercepting section when the voltage of the main or backup power supply is restored to the normal supply voltage range. The control system automatically performs the switchover operation at an optimum time by detecting the phase difference of the main and backup power supplies, and thus damages of a power switch and related circuit elements due to the arc generation on the contacts of the power switch can be prevented.

### BACKGROUND OF THE INVENTION

1. Field of the Invention

The present invention relates generally to a power supply switching device. In particular, the present invention relates to a control system and method for switching and intercepting power supplies which can reduce the generation of arc during the switching operation of the power supplies and adjust the delay time required for the switchover or return of the power supplies by detecting the phase difference between a main power supply and a backup power supply and performing an optimum switching operation according to the detected phase difference.

According to the present invention, the term “switching of power supplies” means the changeover of voltage sources supplied to an electric equipment, and is performed by an automatic power switching mechanism using a switch which operates in a manner that if the failure of a commercial power supply is detected, it switches over to a backup power supply so that the load equipment is provided with a backup power from the backup power supply, while if the commercial power supply is restored, it intercepts the backup power supply, and switches over to the restored commercial power supply so that the load equipment is provided with the commercial power. Such a backup power supply may be a separate power generating equipment, battery with a charging device, combination of the power generating equipment and the battery, or separate power transmission lines for supplying another power supply in a standby state. Also, the term “intercept of a power supply” means the stopping of a power supply by on/off operation of a switch or switching device.

2. Description of the Prior Art

Generally, an electric equipment is provided with a backup power supply and a power switching device in order to rapidly switch the power source of the equipment to the backup power supply when a main power is cut off. Such a power switching device requires the reliability, rapidity and stability in operation.

Specifically, the power switching device should rapidly supply the backup power supply to the equipment in case of need, reduce the surge voltage due to the arc generation during the switchover of the power supplies, and guarantee an accurate operation even though the switchover of the power supplies is repeatedly performed.

The backup power supply may be provided from a separate power generating equipment, or supplied through separate power transmission lines.

According to a conventional manual-type power switching device, the switchover of the power supplies is generally performed using a large-capacity relay or a mechanical switch. If the power failure is detected, the relay or the mechanical switch is manually operated to switch over to the backup power supply.

The conventional manual-type power switching device requires personnel for monitoring the failure of the main power supply and for performing the changeover of the power supplies, so that the expenses of operating the power switching device increase as well as the device does not rapidly cope with the need for the power switchover.

According to a conventional automatic power switching device, the switchover to the backup power supply is automatically performed by detecting the failure of the main power supply. This conventional automatic power switching device does not consider the phase difference between the main and backup power supplies in switching the power supplies.

The conventional automatic power switching device also has the drawback that in case of switching AC power supplies, switching contacts of the power switch produce arcing due to the phase superimposition of the AC power supplies. By this arcing, an instantaneous voltage waveform, which is higher than twice the normal supply voltage and exceeds the withstand voltages of circuit elements, may be applied to the circuit elements, and this causes the deterioration or damage of the circuit elements. Further, according to the conventional automatic power switching device, the operational delay time for the power switchover is not properly adjusted, and thus the proper time required for the normal operation of the main or backup power supply cannot be secured.

### SUMMARY OF THE INVENTION

It is an object of the present invention to solve the problems involved in the prior art, and to provide a power supply switching control system for a power supply switching device which can perform a switching operation of power supplies (i.e., selection of either of two power supplies) by detecting and comparing phases of the power supplies.

It is another object of the present invention to provide a power supply switching and intercepting control system for a power supply switching device which can automatically intercept the power supply if an input supply voltage level deviates from a normal supply voltage range.

In order to achieve the above objects, there is provided a power supply switching and intercepting control system for a power supply switching device having a main power supply, a backup power supply, a power switching section for switching the main and backup power supplies, and a power intercepting section for performing a trip or return operation with respect to the main or backup power supply, the control system comprising: a phase signal input section for detecting phases of the main and backup power supplies and outputting phase detection signals;

a reference voltage generating section for generating and outputting a reference voltage;

a supply voltage input section for detecting voltages of the main and backup power supplies and outputting voltage detection signals; and

a control section for receiving and processing output signals of the phase signal input section, reference voltage generating section, and supply voltage input section, the control section outputting a power switching control signal to the power switching section, outputting a trip signal to the power intercepting section when a voltage of the main or backup power supply deviates from a normal supply voltage range, and outputting a return signal to the power intercepting section when the voltage of the main or backup power supply is restored to the normal supply voltage range.

Preferably, the control section comprises a central processor for comparing the phase detection signals inputted from the phase detecting section and outputting the power switching control signal to the power switching section if the phase difference between the main and backup power supplies is within a predetermined range, thereby preventing an arc generation in the power switching section and thus preventing the circuit elements from being damaged due to the arcing generation.

It is also preferable that the power supply switching and intercepting control system according to the present invention further comprises a switchover time determining section for determining an output delay time for the power switching control signal, a trip time determining section for determining an output delay time for the trip signal, and a return time determining section for determining an output delay time for the return signal. Since the operational delay time for the power switching section and power intercepting section is adjusted by the above-described sections, a proper time required for reaching a stable operation of related devices can be secured.

### BRIEF DESCRIPTION OF THE DRAWINGS

The above objects, other features and advantages of the present invention will become more apparent by describing the preferred embodiments thereof with reference to the accompanying drawings, in which:

FIG. 1 is a block diagram illustrating the construction of the power switching and intercepting control system according to a first embodiment of the present invention.

FIG. 2A is a schematic circuit diagram of a phase signal input section according to a first embodiment of the present invention.

FIG. 2B is a schematic circuit diagram of a reference voltage generating section according to a first embodiment of the present invention.

FIG. 2C is a schematic circuit diagram of a voltage signal generating section according to a first embodiment of the present invention.

FIG. 3 is a flowchart illustrating the switching control operation of the control section according to a first embodiment of the present invention.

FIG. 4 is a block diagram illustrating the whole construction of the power switching and intercepting control system according to a second embodiment of the present invention.

FIG. 5 is a block diagram of the determining section and the display section according to the present invention.

FIG. 6A is a schematic circuit diagram of a phase signal input section according to a second embodiment of the present invention.

FIG. 6B is a schematic circuit diagram of a reference voltage generating section according to a second embodiment of the present invention.

FIG. 6C is a schematic circuit diagram of a voltage signal generating section according to a second embodiment of the present invention.

FIG. 7A is a waveform diagram illustrating the trip operation when the undervoltage is inputted.

FIG. 7B is a waveform diagram illustrating the trip and switching operation when the main power is failed.

FIG. 7C is a waveform diagram illustrating the trip operation when the overvoltage is inputted.

FIG. 8 is a flowchart illustrating the switching control operation of the control section according to a second embodiment of the present invention.

### DETAILED DESCRIPTION OF THE PREFERRED EMBODIMENTS

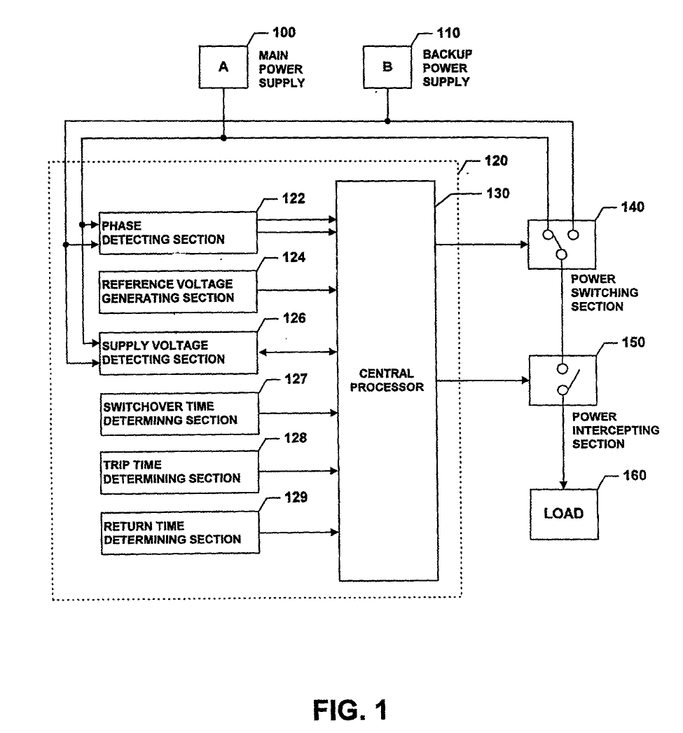

FIG. 1 is a block diagram illustrating the construction of the power switching and intercepting control system according to the present invention.

In FIG. 1, the reference numeral 120 denotes a control unit, 140 denotes a power switching section, 150 denotes a power intercepting section, and 160 denotes a load.

The power switching section 140 performs the switchover from a main power supply 100 to a backup power supply 110 and vice versa in accordance with a switching control signal from the control unit 120, and provides the selected power supply to the load 160.

That is, the power switching section 140 performs a switching operation in accordance with the control signal outputted from the control unit 120, and selects either of the main power supply 100 and the backup power supply 110 to output the selected power supply to the circuits.

The power intercepting section 150 intercepts the power supply selected by and supplied from the power switching section 140 to the load 160 in accordance with a control signal from the control unit 120 if an overcurrent flows through the load 160 or if an overvoltage or undervoltage is supplied to the load 160 as an input supply voltage. This power intercepting section 150 protects the load 160 by intercepting the power supply to the load 160.

The control unit 120 includes a phase signal input section 122, a reference voltage generating section 124, a supply voltage input section 126, a switchover time determining section 127, a trip time determining section 128, a return time determining section 129, and a central processor 130.

The phase signal input section 122 receives the main and backup power supplies 100 and 110, detects the phase difference between the main and backup power supplies, and outputs phase detection signals to the central processor 130. The reference voltage generating section 124 generates and outputs a predetermined reference signal to the central processor 130. The supply voltage input section 126 receives the main and backup power supplies 100 and 110, detects the voltage levels of the main and backup power supplies, and outputs voltage signals to the central processor 130 accordingly. The switchover time determining section 127 determines an operation time for the power switchover, and outputs a switchover time signal to the central processor 130. The trip time determining section 128 determines an operation time for the tripping of the power intercepting section 150 if the overvoltage or undervoltage is supplied, and outputs a trip time signal to the central processor 130. The return time determining section determines an operation time for the returning of the power intercepting section 150 if a normal power supply is restored, and outputs a return time signal to the central processor 130.

The central processor 130 receives the above-described signals, and outputs control signals to the power switching section 140 and power intercepting section 150 by performing a predetermined algorithm. Specifically, the central processor 130 judges the state of the input voltage in accordance with a phase difference value between the main power supply 100 inputted from the phase signal input section 122 and the backup power supply 110, and the overvoltage/undervoltage state of the input power supply obtained by comparing the voltage value inputted from the supply voltage input section 126 and a predetermined reference voltage. The central processor 130 outputs the control signal for controlling the switching operation of the power switching section 140 and the power intercepting section 150 in accordance with a result of judgement.

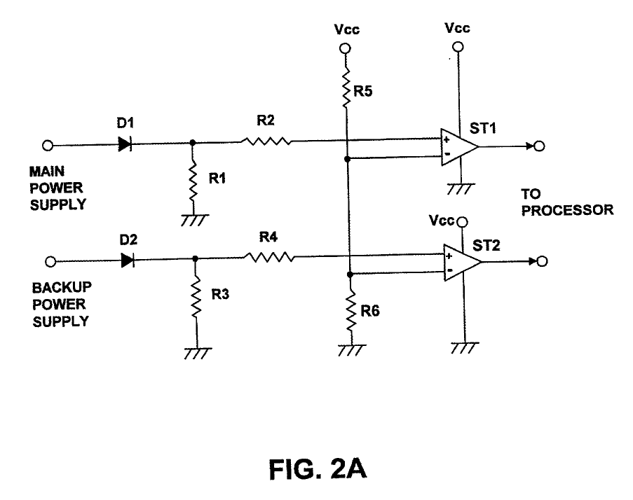

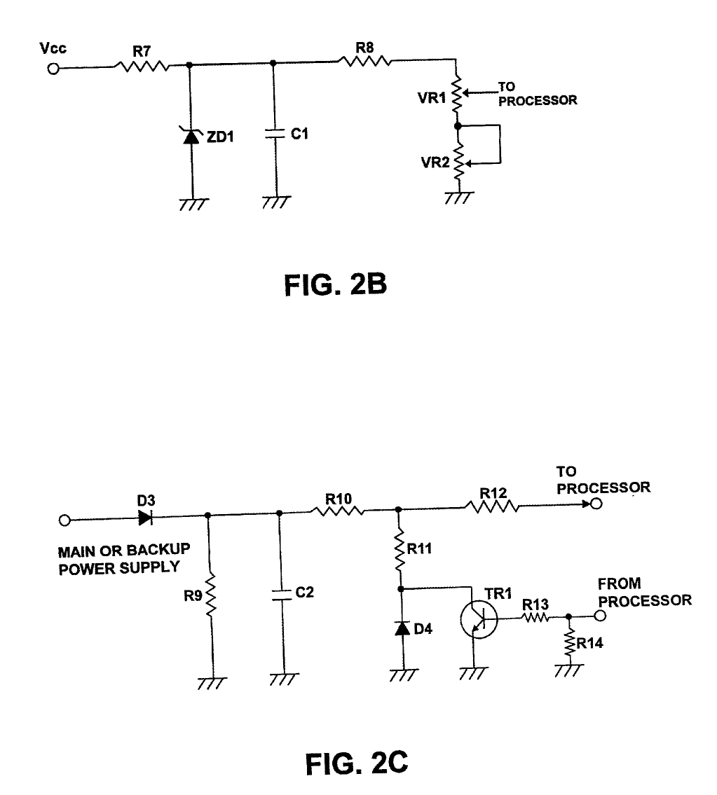

FIG. 2A is a circuit diagram of the phase signal input section according to the first embodiment of the present invention, FIG. 2B is a schematic circuit diagram of the reference voltage generating section according to the first embodiment of the present invention, and FIG. 2C is a schematic circuit diagram of the voltage signal generating section according to the first embodiment of the present invention.

Referring to FIG. 2A, the phase signal input section 122 detects the phases of the main and backup power supplies. The phase signal input section includes a diode D1 for rectifying the main AC power supply, a diode D2 for rectifying the backup AC power supply, voltage dividing resistors R1, R2, R3, and R4 for dividing the ripple voltages rectified by the diodes D1 and D2, respectively, a voltage dividing resistor R13 for providing the reference voltage, and Schmitt trigger type operational amplifiers ST1 and ST2 for receiving the reference voltage through their inverting (−) terminals and receiving the rectified main and backup power supplies through their non-inverting (+) terminals, respectively.

The Schmitt trigger type operational amplifiers ST1 and ST2 commonly receive the reference voltage through their inverting (−) terminals, and thus operate in accordance with the voltage values of the main and backup power supplies received through their non-inverting (+) terminals, respectively.

The ripple voltage, which is rectified from the main power supply and inputted to the non-inverting (+) terminal of the operational amplifier ST1 through the voltage dividing resistors R1 and R2, has a half-wave-rectified waveform. At the same time, the reference voltage, which is obtained by dividing the operational supply voltage Vcc, is inputted to the inverting (−) terminal of the operational amplifier ST1. Accordingly, the operational amplifier ST1 outputs a ‘high’ level signal to the central processor 130 if the voltage applied to its non-inverting terminal becomes higher than the reference voltage applied to its inverting terminal, while it outputs a ‘low’ level signal to the central processor 130 if the voltage applied to its non-inverting terminal becomes lower than the reference voltage applied to its inverting terminal.

Meanwhile, the ripple voltage, which is rectified from the backup power supply and inputted to the non-inverting (+) terminal of the operational amplifier ST2 through the voltage dividing resistors R3 and R4, has a half-wave-rectified waveform. At the same time, the reference voltage, which is obtained by dividing the operational supply voltage Vcc, is inputted to the inverting (−) terminal of the operational amplifier ST2. Accordingly, the operational amplifier ST2 outputs a ‘high’ level signal to the central processor 130 if the voltage applied to its non-inverting terminal becomes higher than the reference voltage applied to its inverting terminal, while it outputs a ‘low’ level signal to the central processor 130 if the voltage applied to its non-inverting terminal becomes lower than the reference voltage applied to its inverting terminal.

Specifically, if the frequency of the input power supply is 60 Hz, a ‘high’ level phase signal of the main power supply, which has a period of 16.67 ms (1/60 second), is inputted to the central processor, and in the same way, a ‘high’ level phase signal of the backup power supply, which has a period of 16.67 ms (1/60 second), is inputted to the central processor.

The central processor judges the synchronization of the main and backup power supplies by measuring the difference between the input times of the phase signals of the main and backup power supplies. For instance, if the phase signal of the backup power supply is inputted when a 16.67/2 ms (i.e., 8.335 ms) elapses after the phase signal of the main power supply is inputted, the central processor judges that the main and backup power supplies have a phase difference of 180° from each other. Accordingly, the central processor judges that the phases of the main and backup power supplies approximate to the same value as the phase difference between the main and backup power supplies approaches to “0”, and that the phases thereof become opposite to each other as the phase difference therebetween approaches to “8.335 ms”.

Meanwhile, the frequency of the main power supply provided by a power supplier is relatively stable, but the frequency of the backup power supply provided by an independent power equipment sharply fluctuates. For instance, if the frequency of the main power supply is fixed to 60 Hz and the frequency of the backup power supply is 50 Hz, the main and backup power supplies repeat the synchronization/asynchronization of the phases with a period of 1.2 s (i.e., 20/16.67 s), and thus the zero-crossing points of the main and backup power supplies coincide with each other with a period of 1.2 s. Such a period of zero-crossing becomes shorter as the frequency difference between the main and backup power supplies becomes larger, while it becomes longer as the frequency difference becomes smaller.

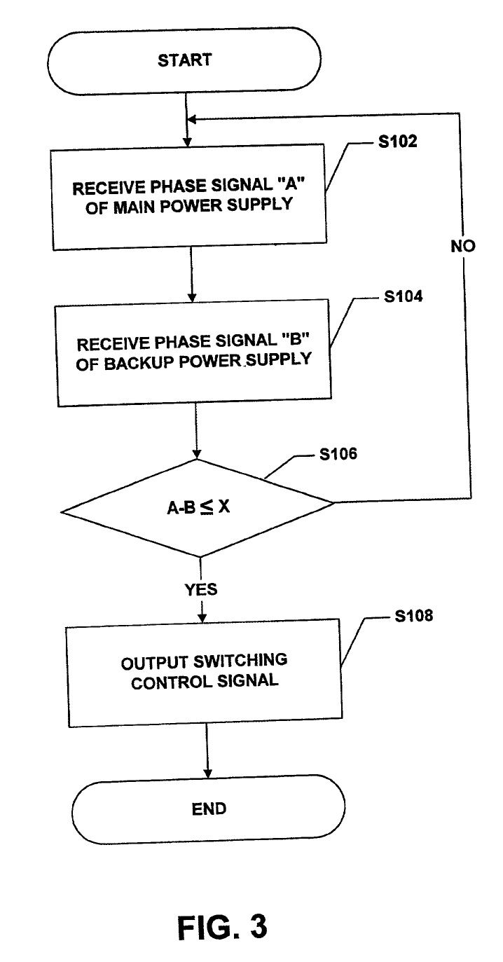

FIG. 3 is a flowchart illustrating the switching control operation of the control section according to the present invention.

Referring to FIG. 3, the central processor of the control section performs a subroutine program for phase comparison and control.

The central processor receives the phase signal A of the main power supply through the operational amplifier ST1 (step S102), and then waits for the input of the phase signal B of the backup power supply. Specifically, if the phase signal A of the main power supply is inputted, the central processor resets a built-in timing counter (not illustrated) so that the timing counter performs a counting operation until the phase signal B of the backup power supply is inputted.

If the phase signal B of the backup power supply is inputted through the operational amplifier ST2 (step S104), the central processor controls the timing counter to stop the counting operation, and calculates the counted value, which represents the time difference value between the input phase signals A and B.

Thereafter, the central processor performs a phase difference comparing step whereby the time difference value between the two input phase signals is compared with a predetermined range X (step S106). Here, the range X can be predetermined by a user.

For instance, if the range of the phase difference value is determined as 10%, the comparison result of “YES” is outputted in case that the two phase signals are inputted with the time difference in the range of 1.67 ms (i.e., 16.67/100×10 ms).

On the contrary, if the comparison result of “NO” is outputted at the comparing step (step S106), the processing step returns to the step of receiving the phase signal A of the main power supply (step S102).

If the comparison result is “YES” at the comparing step (step S106), the central processor outputs the switching control signal to the power switching section (step S108), so that the switchover from the main power supply to the backup power supply is performed.

As described above, the power switchover is performed when the phases of the two power supplies are almost synchronized with each other, and thus the arcing generated between the contacts of the power switch during the power switchover can be reduced.

Referring to FIG. 2B, the reference voltage generating section 124 includes a Zener diode ZD, a voltage regulating capacitor C1, and voltage dividing resistors R1, VR1 and R2. The operational supply voltage Vcc is inputted through the Zener diode ZD, divided by the voltage dividing resistors R1, VR1 and R2, and then supplied to the central processor. The variable resistor VR1 is for the fine adjustment of the reference voltage.

The central processor has a built-in analog-to-digital (A/D) converter for converting the input voltages into digital values, so that it can compare the voltage inputted from the supply voltage detecting section with the reference voltage inputted from the reference voltage generating section.

Referring to FIG. 2C, the voltage signal generating section 126 includes a rectifying diode D1, a smoothing capacitor C1, voltage dividing resistors R1, R2 and R3 for dividing the voltage through the capacitor C1 and providing the divided voltage to the central processor, a transistor TR1 which is turned on or off according to a control signal outputted from the central processor, and a diode D2 for determining a reference voltage.

The input main or backup AC power supply is rectified by the diode D1, and a ripple voltage from the rectifying diode D1 is smoothed through the capacitor C1 to be a DC voltage. The DC voltage is then divided by the voltage dividing resistors R1, R2 and R3 to be outputted to the central processor. At this time, the voltage dividing resistor R3 is coupled to ground through the diode D2 reversely connected therebetween.

Accordingly, if the transistor TR1 is turned off, terminals of the diode D2 maintains a predetermined voltage value. On the contrary, if the transistor TR1 is turned on, the DC voltage from the voltage dividing resistor R3 is bypassed to ground through the collector-emitter of the transistor TR1, causing the terminal voltage of the diode D2 is coupled to the collector-emitter voltage of the transistor TR1 in parallel.

As a result, the voltage value to be inputted to the central processor can be changed according to the existence/nonexistence of the control signal outputted from the central processor. Accordingly, the control system of the present invention can adaptively cope with the change of the supply voltage in the range of 220V^{˜}380V without any circuit reconstruction.

As described above, the central processor has the built-in A/D converter for converting the input voltages into digital values, and thus it can discriminate the input of an overvoltage or undervoltage by comparing the voltage value inputted from the voltage signal generating section with the reference voltage inputted from the reference voltage generating section.

If the input of the overvoltage or undervoltage is detected, the central processor 130 outputs the trip signal to the power intercepting section 150 to trip the power supply. If the supply voltage is restored to the normal state, the central processor outputs the return signal to return to the power supply.

Now, the operation of the switchover time determining section 127, trip time determining section 128 and return time determining section 129 will be explained.

A user may determine the delay time for the switchover operation through the switchover time determining section 127. For example, the switchover time may be determined within the range of 0 to 30 s. If the switchover time is determined, the central processor outputs the switching control signal after the determined time. Under such an operational delay time, the central processor controls to perform the switching operation at an optimum time by comparing the phases of the two power supplies.

The user may also determine the delay time for the trip operation of the power intercepting section 150 through the trip time determining section 128 when an abnormal supply voltage is inputted. The delay time for the trip operation is determined in the same manner as that for the switchover operation, and the central processor controls to perform the trip operation after the delay time.

The user may also determine the delay time for the return operation of the power intercepting section 150 through the return time determining section 129 when the power supply is restored to the normal state.

As described above, the power switching and intercepting control system according to the present invention automatically performs the switchover operation to the backup power supply when the main power supply is failed, and the switchover operation to the main power supply when the main power supply is restored. According to the present invention, since the power switchover is performed at an optimum time by detecting the phase difference of the main and backup power supplies, damages of the power switch and the related circuit elements due to the arcing generated on the contact portions of the power switch can be prevented. Also, according to the present invention, since the power switchover is performed after a delay time required for the normal operation of the respective power supplies, a stable power supply can be achieved.

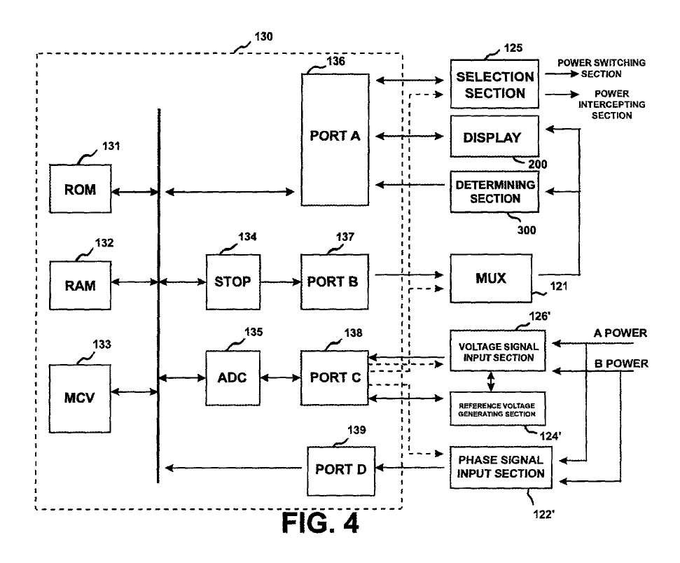

Meanwhile, the control system and method for switching and intercepting power supplies according to the second embodiment of the present invention will be explained with reference to FIGS. 4 to 8. The same reference numerals are given to the same elements as those of the system according to the first embodiment, and detailed explanation thereof will be omitted.

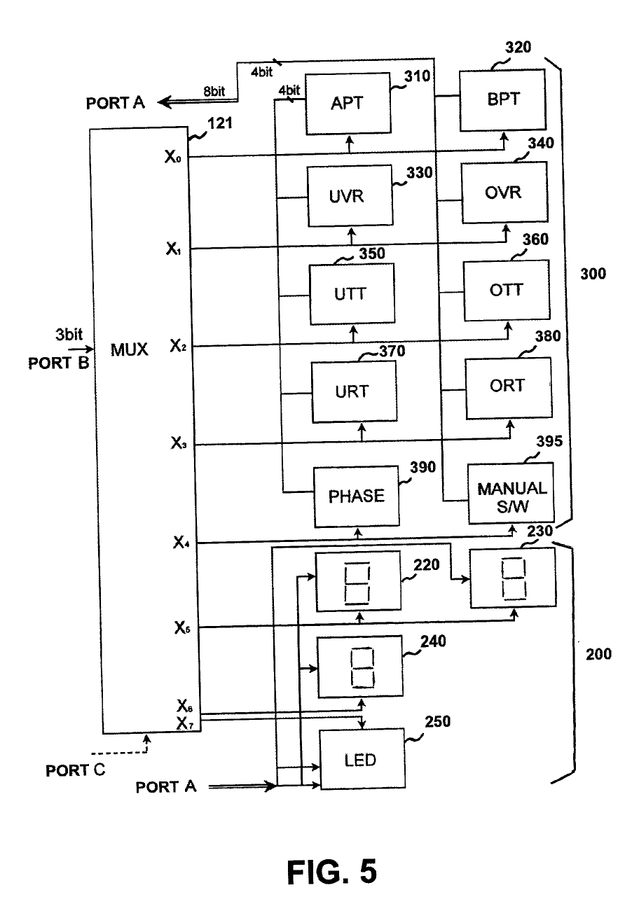

FIG. 4 is a block diagram illustrating the whole construction of the power switching and intercepting control system according to the second embodiment of the present invention, and FIG. 5 is a block diagram of the determining section and the display section.

Referring to FIG. 4, the control unit 120 according to the second embodiment includes a central processor 130, a phase signal input section 122′, a reference voltage generating section 124′, a voltage signal generating section 126′, and a determining section 300 for determining various parameters. In comparison to the first embodiment, the phase signal input section 122′, the reference voltage generating section 124′, and the voltage signal generating section 126′ are slightly modified to perform more functions, and the determining section 300 can designate more parameter values than that of the first embodiment.

For instance, the central processor may be implemented using a ‘68HC705P9’ chip. FIG. 4 illustrates the central processor 130 in detail. Referring to FIG. 4, ports A to D used as input/output ports are connected to a control unit (MCU) 133, RAM 132, and ROM 131 through a internal bus. Specifically, the port B137 is connected to the bus through a synchronous serial input/output port (SIOP) 134, and the port C138 is connected to the bus through an analog-to-digital converter (ADC) 135.

The port A136 is used as a data input/output port, and the display section 200, determining section 300, and selection section 125 are connected to the port A through the same data system bus.

The determining section 300 includes an power timer sections 310 and 320, overvoltage/undervoltage determining sections 330 and 340, overvoltage/undervoltage trip timer sections 350 and 360, overvoltage/undervoltage return timer sections 370 and 380, and allowable phase deviation section/manual switch section 390 and 395. The respective unit of the determining section is allocated with 4 bits, 5 pairs of units are connected to the port A in parallel.

The B power timer 320 determines a delay time in case of the switchover from the A power supply to the B power supply. The A power timer 310 determines a return time when the switchover to the A power supply is effected after the switchover to the B power supply. The delay time and the return time may be determined to be in the range of 0_{˜}60 s, respectively. The delay time or the return time of 0 s means a locking state.

The overvoltage determining section 330 determines an upper limit value of the primary supplied voltage, which is higher than the rated value, to perform the power intercepting for protection of the load. The undervoltage determining section 340 determines a lower limit value of the primary supplied voltage, which is lower than the rated value, to perform the power intercepting for protection of the load. The upper limit value and the lower limit value may be determined to be in the range of 0%_{˜}20% of the rated voltage, respectively. For example, if the overvoltage and the undervoltage are determined to be 10% and 15% of the rated voltage of 220V, respectively, the trip is performed if the input voltage exceeds 242V or becomes less than 187V.

The overvoltage trip timer section 350 determines the delay time for performing the trip if the input voltage is determined to be the overvoltage, and the undervoltage trip timer section 360 determines the delay time for performing the trip if the input voltage is determined to be the undervoltage. This is because the overvoltage or the undervoltage may be temporarily produced due to the switching of the power supply to one of various loads, and in this case, the trip is not required to be performed. The trip delay time may be determined to be in the range of 0 s^{˜}60 s. For example, if the overvoltage trip time delay and the undervoltage trip time delay are determined to be 4 s and 6 s, respectively, the trip is performed in the event that the overvoltage is maintained for over 4 s, or the undervoltage is maintained for over 6 s.

The overvoltage return timer section 370 determines the return time for turning on the switch in case that the trip is performed with respect to the overvoltage, and the undervoltage return timer section 380 determines the return time for turning on the switch in case that the trip is performed with respect to the undervoltage. The return time may be determined to be in the range of 0 s^{˜}60 s. For example, if the overvoltage return time and the undervoltage return time are determined to be 4 s, respectively, the switch is automatically turned on in 4 s after the trip operation.

The determined value of the allowable phase deviation section 390 is used when the power supply is switched from the B power supply (i.e., backup power supply) to the A power supply (i.e., main power supply)(The switchover from the main power supply to the backup power supply is performed when the failure of the main power supply occurs, and in this case, it is not required to consider the phase). The allowable phase deviation section 390 determines in what phase difference between the B power supply and the A power supply the switchover is performed. The phase difference may be determined within 50% (i.e., 90°).

The manual switch section 395 is used to manually perform the switchover of the power supply or the trip. This is apart from the subject matter of the present invention, and thus detailed explanation thereof will be omitted.

The display section 200 serves to display the current voltage value and the operating state of the control system. As shown in FIG. 5, it may includes three digits 220, 230, and 240 so as to display the voltage value of three figures. Also, to the port A is connected in parallel an LED section 250 for displaying a normal/abnormal state of the control system, a voltage intercepting control state, a voltage switchover state, and a main power supply state.

Accordingly, the determining section and the display section are composed of parallel circuits on 8 pairs of 8-bit data bus lines, and one among them is activated at a predetermined time by enable signals x0^{˜}×7 from a multiplexer 121. Then, the multiplexer activates one among the 8 enable signals at a specified time point through the 3-bit data lines from the port B137.

Meanwhile, the control signal of the power switching section and the control signal of the power intercepting section are outputted from the control unit 120 through the selection section 125 which is also connected to the port A in parallel. Either of the selection section and the multiplexer is activated by the control signal from the port C138, and uses the data system common bus at the specified time point.

Meanwhile, the voltage signal input section 126′ and the phase signal input section 122′ are connected in parallel to the A power supply and the B power supply. The voltage signal input section inputs information on the supply voltage to the port C138, and this supply voltage information is converted into a digital value by the ADC 135. At this time, the port C gives a signal to the reference voltage generating section 124′, so that a proper reference voltage to be compared is generated from the reference voltage generating section, and then inputted to the voltage signal input section. This operation will be explained in detail later.

Finally, the phase signal input section 122′ inputs information on the phase difference between the A power supply and the B power supply to the control unit through the port D in accordance with the control signal from the port C.

In the same manner as the first embodiment, the power switching section 140 and the power intercepting section 150 operate in accordance with the control signal of the control unit 120, select the power supply to the load 160, and perform the switching or intercepting operation.

The functions of the phase signal input section 122, the reference voltage generating section 125, and the voltage signal input section 126 are similar to those of the first embodiment.

The central processor 130 performs the same function as the first embodiment. The central processor 130 receives the above-described input signals, and outputs control signals to the power switching section 140 and power intercepting section 150 by performing a predetermined algorithm. Specifically, the central processor 130 judges the state of the input voltage in accordance with a phase difference value between the main power supply 100 inputted from the phase signal input section 122 and the backup power supply 110, and the overvoltage/undervoltage state of the input power supply obtained by comparing the voltage value inputted from the supply voltage input section 126 and a predetermined reference voltage. The central processor 130 controls the trip operation of the power intercepting section 150 in accordance with a result of judgement, confirms whether the main power supply is failed, and outputs the power switchover control signal in case of the power failure so that the power switching section 140 switches over the power supply to the main power supply.

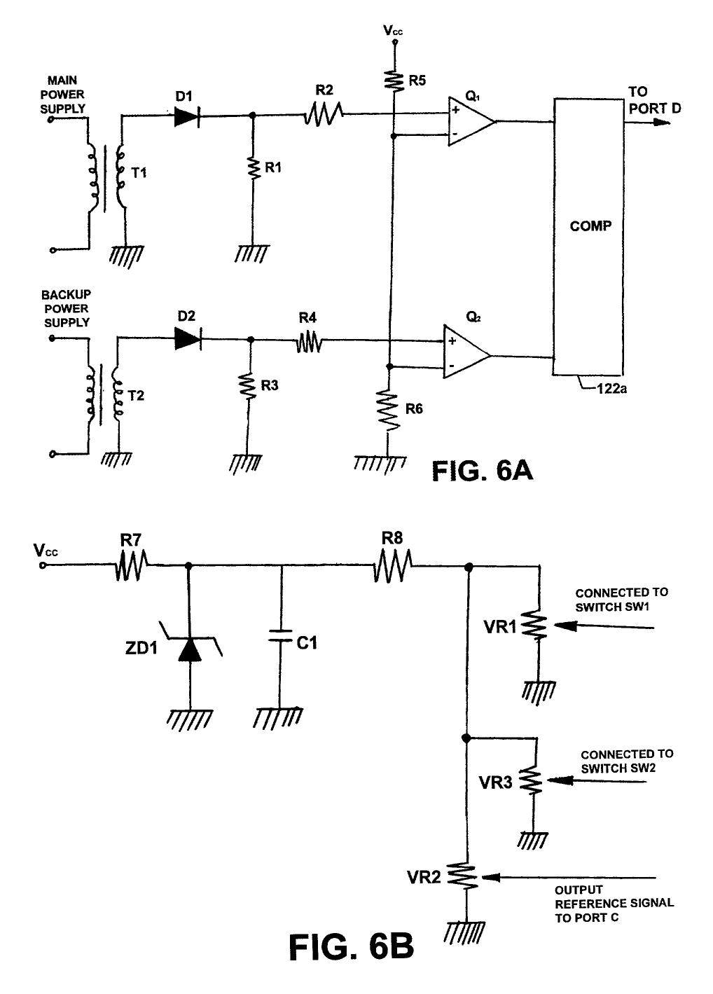

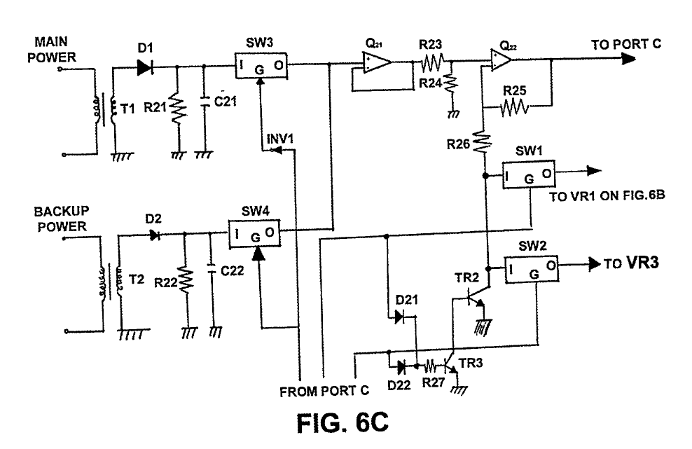

FIG. 6A is a schematic circuit diagram of the phase signal input section, FIG. 6B is a schematic circuit diagram of the reference voltage generating section, and FIG. 6C is a schematic circuit diagram of the voltage signal generating section according to the second embodiment of the present invention. These circuits are similar to those of the first embodiment illustrated in FIGS. 2A to 2C, and hereinafter, the second embodiment of the present invention will be explained with the difference therebetween as the control figure.

Referring to FIG. 6A, the phase signal input section 122′ is connected to the main power supply and the backup power supply through transformers T1 and T2, and detects the phases of the main and backup power supplies from information on the properly transformed main and backup power supplies. The phase signal input section 122′ includes a diode D1 for rectifying the AC supply voltage from the transformer T1 connected to the main power supply, a diode D2 for rectifying the AC supply voltage from the transformer T2 connected to the backup power supply, voltage dividing resistors R1, R2, R3, and R4 for dividing the ripple voltages rectified by the diodes D1 and D2, respectively, voltage dividing resistors R5 and R6 for providing the reference voltages, and Schmitt trigger type operational amplifiers Q1 and Q2 for receiving the reference voltages through their inverting (−) terminals and receiving the rectified main and backup power supplies through their non-inverting (+) terminals, respectively. Outputs of the Schmitt trigger type operational amplifiers Q1 and Q2 are inputted to the comparator section (COMP) 122a, and thus an output of the comparator section includes information on the phase difference between the two input signals. The phase difference signal is inputted to the port D of the central processor.

The Schmitt trigger type operational amplifiers Q1 and Q2 of the phase signal input section commonly receive the reference voltages from the voltage dividing resistors R5 and R6 through their inverting (−) terminals, and thus operate in accordance with the voltage values of the main and backup power supplies received through their non-inverting (+) terminals, respectively.

The ripple voltage, which is rectified from the main power supply and inputted to the non-inverting (+) terminal of the operational amplifier Q1 through the voltage dividing resistors R1 and R2, has a half-wave-rectified waveform. At the same time, the reference voltage, which is obtained by dividing the operational supply voltage Vcc, is inputted to the inverting (−) terminal of the operational amplifier Q1. Accordingly, the operational amplifier Q1 outputs a ‘high’ level signal to the comparator section 122a if the voltage applied to its non-inverting terminal becomes higher than the reference voltage applied to its inverting terminal, while it outputs a ‘low’ level signal to the comparator section 122a if the voltage applied to its non-inverting terminal becomes lower than the reference voltage applied to its inverting terminal.

Meanwhile, the ripple voltage, which is rectified from the backup power supply and inputted to the non-inverting (+) terminal of the operational amplifier Q2 through the voltage dividing resistors R3 and R4, has a half-wave-rectified waveform. At the same time, the reference voltage, which is obtained by dividing the operational supply voltage Vcc, is inputted to the inverting (−) terminal of the operational amplifier Q2. Accordingly, the operational amplifier Q2 outputs a ‘high’ level signal to the comparator section 122a if the voltage applied to its non-inverting terminal becomes higher than the reference voltage applied to its inverting terminal, while it outputs a ‘low’ level signal to the comparator section 122a if the voltage applied to its non-inverting terminal becomes lower than the reference voltage applied to its inverting terminal.

The comparator section judges the synchronization of the two input power supplies by measuring the difference between instantaneous voltage values that represents information on the both phase signals of the input power supplies.

Next, referring to FIG. 6B, the reference voltage generating section 124′ includes a resistor R7 for circuit protection, a Zener diode ZD1, a voltage regulating capacitor C1, and voltage dividing resistors R8, VR1, VR2, and VR3. The operational supply voltage Vcc is inputted through the Zener diode ZD1, divided by the voltage dividing resistors R8, VR1, VR2, and VR3, and then supplied to the port C of the central processor as a primary reference value. The variable resistors VR1 and VR3 are connected to the variable resistor VR2 in parallel, and the variable resistors VR1 and VR3 are connected to switches SW1 and SW2 of the voltage signal input section 126′ of FIG. 6C to divide the voltages supplied to the switches. For example, the voltages divided by the variable resistors VR1 and VR3 may be used to represent the reference value of the overvoltage and the reference value of the undervoltage.

As described above, the central processor has a built-in analog-to-digital (A/D) converter 135 for converting the input voltages into digital values, so that it can compare the voltage inputted from the voltage signal input section with the reference voltage inputted from the reference voltage generating section.

Referring to FIG. 2C, the voltage signal generating section 126′ includes transformers T1 and T2 to which the main power supply and the backup power supply are inputted, and rectifying diodes D1 and D2. The rectified voltage signals are inputted to input terminals of the switches SW3 and SW4 through smoothing capacitors C21 and C22 and resistors R21 and R22, and output terminals of the switches are connected to a non-inverting input terminal (+) of an amplifier Q21 acting as a voltage follower. Also, gates of the switches SW3 and SW4 are connected to the port C of the central processor. Accordingly, the central processor can select either of the main and backup power supplies to be measured by alternately turning on/off the switches SW3 and SW4. The output terminal of the voltage follower is connected to one input terminal of the amplifier Q22 for generating the voltage signal through dividing resistors R23 and R24. To the other input terminal of the amplifier Q22 is applied the voltage divided by the variable resistors VR1 and VR3 of the reference voltage generating section of FIG. 6B through the switches SW1 and SW2 and the resistor R26. The other input thereof is fed back to the output terminal thereof through the resistor R25. Accordingly, in accordance with the control signal from the port C of the central processor, the switching section D21, D22, R27, TR2, and TR3 selects either of the divided voltages from the variable resistors VR1 and VR3, and applies the selected voltage to the other input terminal of the amplifier Q22.

The input main and backup AC power supplies are rectified by the diodes D1 and D2, and ripple voltages from the rectifying diodes D1 and D2 are smoothed through the capacitors C21 and C22 to form DC voltages. One of the DC voltages is selected by the switches SW3 and SW4, and the selected DC voltage is divided by the voltage dividing resistors R23 and R24, and then amplified by the amplifier Q22 to be outputted to the C port of the central processor.

The voltage value to be inputted to the central processor can be changed according to the existence/nonexistence of the control signal outputted from the central processor. Accordingly, the control system of the present invention can adaptively cope with the change of the supply voltage in the range of 220V˜380V.

As described above, the central processor has the built-in A/D converter for converting the input voltages into digital values, and thus a digital voltage value is inputted to the control unit 133. Accordingly, it can discriminate the input of an overvoltage or undervoltage by comparing the voltage value inputted from the voltage signal generating section with the reference voltage inputted from the reference voltage generating section.

If the input of the overvoltage or undervoltage is detected, the central processor 130 outputs the trip control signal to the power intercepting section 150 to trip the power supply. If the supply voltage is restored to the normal state, the central processor outputs the return control signal to return to the power supply.

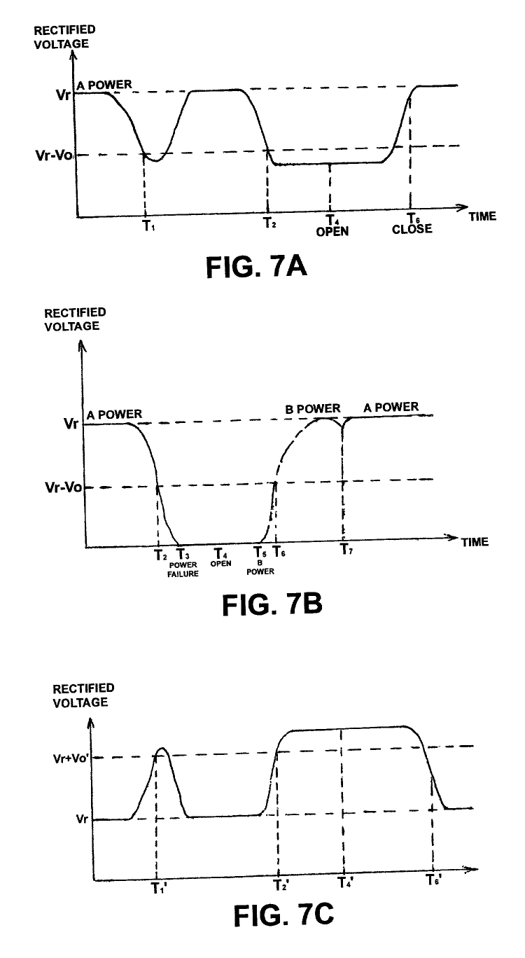

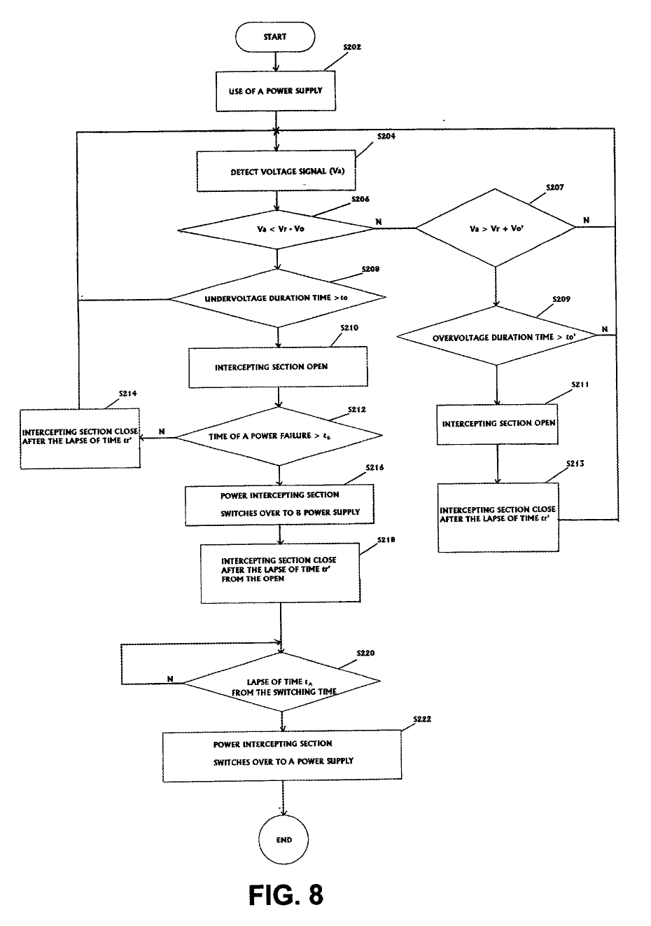

FIG. 7A is a waveform diagram illustrating the trip operation when the undervoltage is inputted, FIG. 7B is a waveform diagram illustrating the trip and switching operation when the main power is failed, and FIG. 7C is a waveform diagram illustrating the trip operation when the overvoltage is inputted. FIG. 8 is a flowchart illustrating the switching control operation of the control section according to the second embodiment of the present invention.

As shown in FIGS. 7A and 8, while the A power supply that is the main power supply is firstly inputted (step S202), the voltage signal Va is periodically detected by the voltage signal input section (step S204), and it is checked whether or not the detected voltage signal Va is the undervoltage that is below the lower limit value Vr−Vo (step S206). If so, the time period where the undervoltage is maintained is counted, and it is checked whether or not the time period is longer than the predetermined value t0 (step S208). If the time period is shorter than the predetermined value t0 though the supplied voltage is below the predetermined value Vr−Vo, the trip is not performed. This is because it is judged that the undervoltage is caused by the instantaneous voltage change due to the switching on of the load, not by any problem of the power supply. As described above, the delay time can be adjusted in optimum to match the characteristics of the load and the power supply.

However, if the supply of the undervoltage is maintained (for example, t2 of FIG. 7a) for a predetermined time (for example, t0 of FIG. 8), it is judged that there exists a problem in the power supply, and the load circuit is required to be protected. In this case, the power supply is intercepted by the intercepting section at the time point t4 to which the undervoltage is maintained (step S210). In case of performing the trip, the switch is turned on again to continue the power supply to the load after the lapse of the undervoltage return time tr, i.e., at the time point t6 where it is assumed that the power supply is stabilized (step S214).

Now, the power switching and intercepting operation will be explained with reference to FIGS. 7B and 8 on the assumption that the main power supply is failed.

If the power failure occurs during the use of the A power supply (step S202), the voltage signal input section 126′ detects the power supply in accordance with the control command of the central processor (step S204). If the detected voltage is lower than the lower limit value Vr−Vo (step S206), the central processor measures the undervoltage duration time. If the undervoltage is maintained over a predetermined delay time t0 (i.e., t4−t2≧t0) (step S208), the central processor makes the intercepting section open at the time point t4 (step S210). Meanwhile, in case that the A power supply is failed, the central processor judges whether or not the time elapsed from the time point t3 of power failure is longer than a predetermined delay time tB (step S212). If the elapsed time is not longer than the delay time tB, the central processor makes the switch of the power intercepting section closed to return to the normal operation state after a predetermined return time as shown in FIG. 7A (step S214), while, if the elapsed time is longer than the delay time tB, the central processor makes the switch of the power intercepting section switches over to the B power supply that is the backup power supply at a predetermined time point t5 (step S216). Also, the central processor closes the switch of the power intercepting section 150 at a time point t6 where the predetermined return time tr has elapsed from the time point t4 where the switch of the power intercepting section is open (step S218), and thus an adverse effect due to a serge voltage occurring during the switching operation can be minimized. After the switchover to the B power supply, the central processor counts the lapse of a predetermined return time tA from the switching time point t5 (step S220), and makes the power switching section 140 switch over to the A power supply that is the main power supply at a time point t7 where the predetermined time has elapsed (step S222). At this time, the switchover to the A power supply is performed by a subroutine of FIG. 3. Specifically, since both the B power supply that is the backup power supply and the A power supply that is the main power supply are supplied, it performs the switching operation in the event that the phase difference between the main power supply and the backup power supply is below the predetermined value (‘x’ of FIG. 3). As a result, since the switchover of the main and backup power supplies is performed at a moment that the phases of the main and backup power supplies are synchronized, the generation of arc during the switching operation of the power supplies can be reduced.

Meanwhile, the power intercepting operation in case that the overcurrent is inputted will be explained with reference to FIGS. 7C and 8.

Referring to FIGS. 7C and 8, if the detected voltage Va is higher than the upper limit value Vr+Vo′ (step S207), the central processor measures the overvoltage duration time, and if the overvoltage is maintained over a predetermined delay time t0′ (t4−t2≧t0′)(step S209), the central processor makes the intercepting section open at the time point t4 (step S211).

As described above, at step S202, the voltage signal input section 126′ periodically detects the voltage signal (step S204), and checks whether or not the detected voltage Va is lower than the lower limit value Vr−Vo (step S206). If it is checked that the voltage Va is not lower than the lower limit value, the central processor checks whether the overvoltage is inputted (step S207), while if not, the central processor returns to the initial state to periodically detects the voltage signal. If it is checked that the over voltage is inputted, the central processor measures the overvoltage duration time, and checks whether or not the overvoltage is maintained over a predetermined delay time t0 (step S209). If the overvoltage duration time is below the predetermined value t0′ though the supplied voltage becomes over the predetermined value Vr+Vo′, the trip is not performed. This is because it is judged that the overvoltage is caused by the instantaneous voltage change due to the switching off of the load, not by any problem of the power supply. As described above, the delay time can be adjusted in optimum to match the characteristics of the load and the power supply.

However, if the supply of the overvoltage is maintained (for example, t2′ of FIG. 7C) for a predetermined time (for example, t0′ of FIG. 8), it is judged that there exists a problem in the power supply, and the load circuit is required to be protected. In this case, the power supply is intercepted by the intercepting section at the time point t4′ to which the overvoltage is maintained (step S211). In this case, the switch of the power intercepting section is turned off again to continue the power supply to the load after the lapse of the overvoltage return time tr′, i.e., at the time point t6′ where it is assumed that the power supply is stabilized (step S213).

Meanwhile, the order of the judgement of the overvoltage and the undervoltage (steps S206 and S207) can be determined by a program, and the respective delay times, return times, upper/lower limit values, and allowable phase deviation can be adjusted in accordance with the characteristics of the load circuit and a large power supply. For example, FIG. 8 shows a flowchart illustrating the power switching control operation wherein the reference value of the undervoltage duration time is determined to be shorter than the delay time tB for switchover to the B power supply. If the determined values of the respective delay times are changed, the control system performs an entirely different operation.

As described above, the power switching and intercepting control system according to the present invention automatically performs the switchover operation to the backup power supply when the main power supply is failed, the switchover operation to the main power supply when the main power supply is restored, intercepting and return operation when the overvoltage or undervoltage is inputted. According to the present invention, since the power switchover is performed at an optimum time by detecting the phase difference of the main and backup power supplies, damages of the power switch and the related circuit elements due to the arcing generated on the contact portions of the power switch can be prevented. Also, according to the present invention, since the power switchover is performed after a delay time required for the normal operation of the respective power supplies, a stable power supply can be achieved. Also, by easily changing the respective parameters, an optimum environment can be provided with respect to the circuit.

While the present invention has been described and illustrated herein with reference to the preferred embodiments thereof, it will be understood by those skilled in the art that various changes in form and details may be made therein without departing from the spirit and scope of the invention.

What is claimed is:

1. A power supply switching and intercepting control system including a central processor 130 for producing signals for controlling switching operations of a power switching section 140 for switching main and backup power supplies A and B, and a power intercepting section 150 for performing trip and return operations with respect to the input power supplies, phase signal input sections 122 and 122′ for inputting phase difference information of the main and backup power supplies to the central processor, voltage signal input sections 126 and 126′ for inputting signals corresponding to voltage values of the respective power supplies to the central processor, and reference voltage generating sections 124 and 124′ for generating and inputting reference voltages to the central processor and the voltage signal input sections;
wherein the central processor makes the power intercepting section temporarily stop the power supply in case that the main power supply is supplied with its voltage below a predetermined lower limit value Vr−Vo for an undervoltage trip delay time t0, or in case that the main power supply is supplied with its voltage above a predetermined upper limit value Vr+Vo′ for an overvoltage trip delay time t0′, makes the power switching section perform switchover to the backup power supply after a first predetermined delay time tB in case that the undervoltage is supplied due to a failure of the main power supply, makes the power intercepting section restore to the main power supply after predetermined return times tr and tr′ elapses after the power interception, and makes the power switching section switch over to the main power supply after a second predetermined delay time tA, and at this time, the switchover from the backup power supply to the main power supply is performed at a time point where the phase difference between the main and backup power supplies that is detected from the phase difference signal inputted from the phase signal input sections is within a predetermined range x; and
wherein the trip delay times t0 and t0′, the return times tr and tr′, the first and second delay times tB and tA, the upper and lower limit values Vr−V0 and Vr+Vo′, and the predetermined range x can be adjusted by a determining section 300, and optimum parameters for characteristics of loads and system can be selected by inputting values adjusted by the determining section to the central processor, whereby the loads are prevented from being adversely affected by the supply of the overvoltage or the undervoltage, and the loads and system are prevented from being adversely affected by a serge current occurring during the power switching operation or an ark occurring from the power switching section.

2. The power supply switching and intercepting control system as claimed in claim 1, wherein values of the undervoltage trip delay time t0, the undervoltage return time tr, and the first delay time tB are properly determined so that the power intercepting operation of the power intercepting section, the switchover operation of the power switching section to the backup power supply, and the power restoring operation of the power intercepting section are performed in order.

3. A method of controlling a power supply switching and intercepting control system including a central processor 130 for producing signals for controlling switching operations of a power switching section 140 for switching main and backup power supplies A and B, and a power intercepting section 150 for performing trip and return operations with respect to the input power supplies, phase signal input sections 122 and 122′ for inputting phase difference information of the main and backup power supplies to the central processor, voltage signal input sections 126 and 126′ for inputting signals corresponding to voltage values of the respective power supplies to the central processor, and reference voltage generating sections 124 and 124′ for generating and inputting reference voltages to the central processor and the voltage signal input sections, the method comprising the steps of:
producing an intercepting control signal to the power intercepting section in case that the main power supply is supplied with its voltage below a predetermined lower limit value Vr−Vo for an undervoltage trip delay time t0;
producing to the power switching section a switching control signal for switchover to the backup power supply after a first predetermined delay time tB in case that the undervoltage is supplied due to a failure of the main power supply;
producing a restoring control signal to the power intercepting section after a predetermined return time tr elapses after the power intercepting section produces the intercepting control signal;
producing again to the power switching section a switching control signal for switchover to the main power supply after a second predetermined delay time tA after the power switching section produces the switching control signal for switchover to the backup power supply;
producing an intercepting control signal to the power intercepting section in case that the main power supply is supplied with its voltage above a predetermined upper limit value Vr+Vo′ for an overvoltage trip delay time t0′; and
producing again a restoring control signal to the power intercepting section after a second return time tr′ elapses after the power intercepting section produces the overvoltage intercepting control signal;
wherein the power switching control signal for switchover to the main power supply is performed at a time point where the phase difference between the main and backup power supplies that is detected from the phase difference signal inputted from the phase signal input sections is within a predetermined range x; the trip delay times t0 and t0′, the return times tr and tr′, the first and second delay times tB and tA, the upper and lower limit values Vr-V0 and Vr+Vo′ and the predetermined range x can be adjusted by a determining section 300; and optimum parameters for characteristics of loads and system can be selected by inputting values adjusted by the determining section to the central processor; whereby the loads are prevented from being adversely affected by the supply of the overvoltage or the undervoltage, and the loads and system are prevented from being adversely affected by a serge current occurring during the power switching operation or an ark occurring from the power switching section.
